(19) United States
(12) Patent Application Publication
(10) Pub. No.: US 2005/0251486 A1
(43) Pub. Date: Nov. 10, 2005

(54) System and methods for protecting digital works using a watermark gateway

(76) Inventor: Mark Nair, Amarillo, TX (US)

Correspondence Address: NIXON PEABODY, LLP, 401 9TH STREET, NW, SUITE 900, WASHINGTON, DC, 20004-2128, US

(21) Appl. No.: 11/049,287

(22) Filed: Feb. 3, 2005

Related U.S. Application Data
(60) Provisional application No. 60/541,057, filed on Feb. 3, 2004.

(51) Int. Cl. H04K 1/00

(52) U.S. Cl. 705/57

(57) ABSTRACT

A system and method for preventing the transfer of illicit digital files employs a digital watermark detector and gateway to control the transmission and delivery of electronic files. The system blocks transmission and reception of a digital file upon detecting a watermark, where the presence of a watermark indicates that the digital file has been illegitimately copied or distributed in violation of a content owner's rights.

### CROSS-REFERENCE TO RELATED APPLICATIONS

This non-provisional application claims benefit of priority to provisional application Ser. No. 60/541,057 filed on Feb. 3, 2004. The disclosures of that application and others referenced are incorporated herein by reference.

### FIELD OF THE INVENTION

The invention relates generally to techniques for protecting digital data files from unauthorized use and piracy. More particularly, the invention relates to a digital watermark system and method for embedding watermark information within a file and a gateway system to block the transfer of illicit files while permitting transfer of authorized data.

### BACKGROUND OF THE INVENTION

The birth of the Internet and the ease of information exchange has created problems for owners of digital works, perfect copies of which can be transmitted to any number of people with ease. Pirated or unauthorized digital transactions occur with such frequency that it is nearly impossible to stop the millions of people who misappropriate and infringe upon copyright every day. This is especially true when dealing with new, anonymous peer-to-peer (PTP) networks that block or mask the identity of users, e.g., their Internet Protocol (IP) identification number.

Although digital watermarks embedded into the signal of electronic files are known, the usage of these watermarks is rare because of two problems. First, adding the watermarks to the underlying document has either corrupted or changed the original digital work in a way to make that work unusable or of lesser value than it had before the addition of the watermark. For instance, traditional methods of adding a digital watermark to an audio file distort the audio file enough so that its watermarked-representation is a pale imitation of the original. The second problem is forensic in nature. It has been difficult to track a personalized watermark on an illegally distributed file because of the lack of a mechanism, either through the Internet or some other network, for the file to contact home, check its status, and determine whether that particular file has or has not been copied legitimately. Plus, once a watermark is determined, there is an issue with enforcement of rights, i.e., the owner must actively enforce them.

Recent technological breakthroughs have substantially addressed the first concern. Indeed, today watermarking technology has progressed to a point where the watermark in a digital file does not adversely affect the performance or quality of the original file noticeably. Adding a watermark, of course, does change the original because a watermark is intrinsic to the file and does not act as a “wrapper” or any other non-additive change to the file, but recent advances in the technology can calm content owners' fears of a watermark unjustifiably corrupting, altering or destroying their original work.

Additionally, adding a watermark to a file has until recently required dedicated processor time and energy, but computational power and improvements in watermark algorithms have decreased the time needed to create and add a watermark to a digital file. These additions can now happen in real-time, so that once a file is requested for delivery, a watermark can be added by the distribution server with virtually no time penalty.

Even with these improvements in watermarking technology, however, it is still difficult to use these technologies to solve the current problem of illegal media distribution through file sharing networks, chat networks, or any other of the various ways users can communicate and deliver illicit digital files to other users. The present invention offers a solution to this dilemma.

### SUMMARY OF THE INVENTION

The system and method of the present invention secures files from illicit copying and permits the transfer of authorized data by automatically recognizing watermarked files and employing electronic gateways to stop the transfer of unauthorized watermarked files.

### BRIEF DESCRIPTION OF THE DRAWINGS

The above-mentioned and other features of this invention and the manner of attaining them will become more apparent, and the invention itself will be better understood, by reference to the following description of embodiments of the invention taken in conjunction with the accompanying figures where:

FIG. 1 illustrates a conventional network system;

FIG. 2 illustrates a networked system in accordance with the present invention;

FIG. 3 illustrates the steps of the method of blocking illicit file transfers in accordance with the present invention;

FIG. 4 illustrates a gateway detector in accordance with the present invention; and

FIG. 5 illustrates a process of adding a watermark and tracking the watermark through a network.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

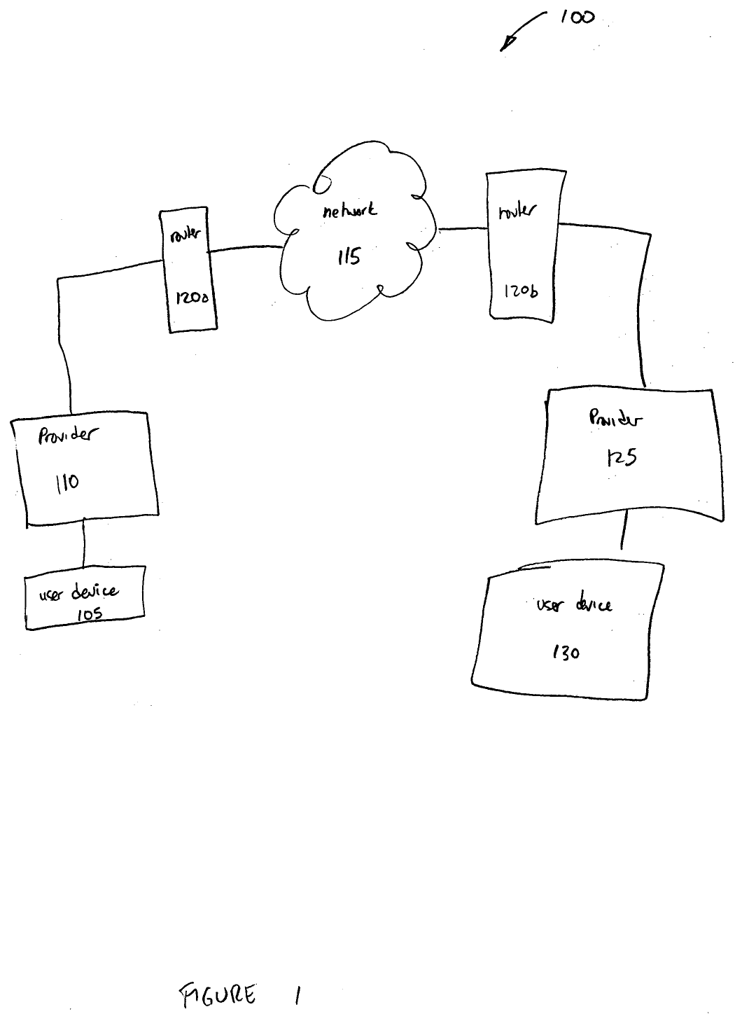

With reference to FIG. 1, there is illustrated a general networking environment, designated generally by the reference numeral 100, in use by countless millions of users each day. In this system, a user device 105 is connected to a provider 110, such as an Internet Service Provider (ISP), which connects the user to a network 115, such as the Internet. As is known in the art, data or information such as in an electronic file, are transmitted across the network 115 via routers 120a, 120b. Thus, the user can send an email through provider 110 across the network 115 to another user. At the other end, the other user has a provider 125, which receives the transmission, and ports the information to the other user at their user device 130. For example, a song or other digital work can be attached to an email at user device 105, sent out to the network 115 and received and downloaded at user device 130, where the receiving user has a perfect copy of the digital work. Although there are innumerable legitimate file transfers between users, there are also countless illegitimate and illegal downloads and transfers of copyright, trade secret, or otherwise protected information.

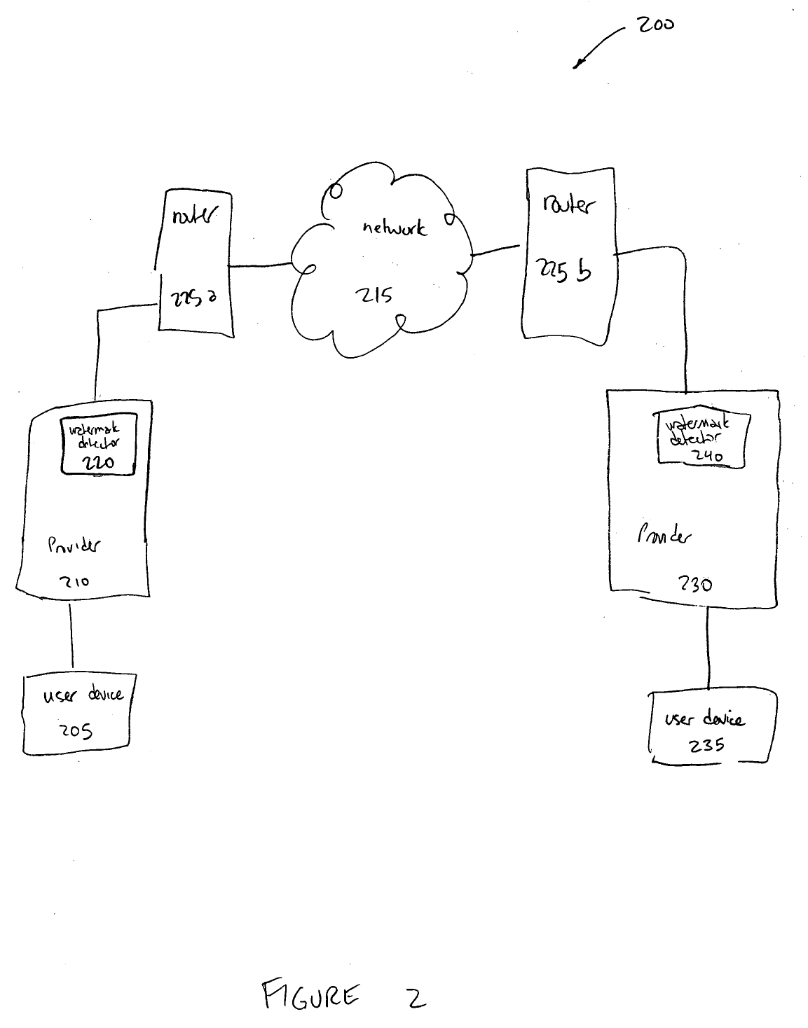

With reference to FIG. 2, there is illustrated an improved system in accordance with the principles of the present invention. In this system, designated generally by the reference numeral 200, a user device 205 is connected to a provider 210, such as an ISP, which connects the user to a network 215, such as the Internet. Unlike the system 100, however, which provides little or no control over the dissemination of information, proprietary or otherwise, across the network, the paradigm of the present invention does. In particular, a watermark detector gateway 220 is employed by the provider 210 to detect the presence or absence of a valid watermark in the data or file to be released onto the network 215.

If the file to be transmitted or disseminated has no watermark therein, that is, the watermark detector gateway 220 has no indication of an inappropriate transfer, then the information passes to the other user across the network 215. However, should the watermark detector gateway 220 detect the presence of a valid watermark in the file in question, then the outbound transfer to the network 215 is blocked. In a preferred embodiment of the present invention, the software or hardware necessary to decode a watermark resides within the provider 210. In another preferred embodiment of the present invention, the software or hardware to decode a watermark is separate from, and communicates with, the provider 210.

A digital file that can be watermarked may be an audio file, such as a music file, or may be another digital media file, such as video or image. Any or all of these files and others can be watermarked. Examples of methods of monitoring and decoding existing watermarks on digital files may be found in U.S. Pat. No. 6,647,128, “Method for monitoring internet dissemination of image, video, and/or audio files,” to Rhoads and U.S. Pat. No. 6,724,914, “Progressive watermark decoding on a distributed computing platform,” to Brundage, et al. Examples of methods of adding watermarks to digital files may be found in U.S. Pat. No. 6,643,386, “Method and apparatus for adding watermarks to images and/or video data streams,” to Foster and U.S. Pat. No. 6,584,210, “Digital watermark image processing method,” to Taguchi, et al.

With further reference to FIG. 2, when a file makes it past the watermark detector gateway 220, i.e., no watermark is present, the file transits across the network 215, such as the Internet, via routers 225a, 225b to another provider 230 servicing another user at user device 235. As shown in FIG. 2, provider 230, as with provider 210, has a watermark detector gateway 240 attached thereto to detect the presence or absence of a valid watermark in files coming and going through this gateway. Thus, in addition to detecting watermarks prior to release of a file onto a network, the watermark detector gateway 220, 240 also detects the presence or absence of a valid watermark on incoming transfers. That is, the watermark detector gateways operate bidirectionally.

Thus, if an incoming file from user device 205 or any other source has no watermark to indicate an inappropriate transfer, the watermark detector gateway 240 allows the incoming file to pass through and then on to the user device 235. However, should the watermark detector gateway 240 detect a valid watermark, then the transfer in is blocked.

An additional embodiment of the present invention includes a peer-to-peer network, as is known in the art. Rather than a provider connecting users to the Internet via a router, and passing all data files incoming or outgoing through a watermark detector gateway, in a peer-to-peer network, a provider would connect users directly one to another, passing all data files to be shared through a watermark detector gateway.

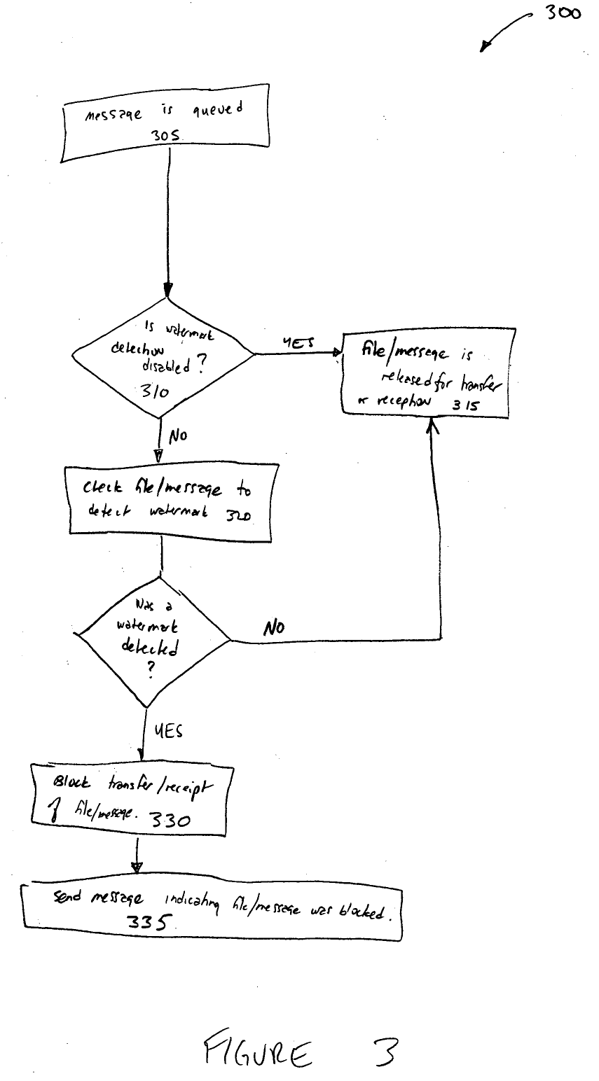

With reference now to FIG. 3, there is shown a methodology of operation for the watermark detector gateways 220, 240, generally designated in the figure by the reference numeral 300. At the provider or ISP level where the watermark detector gateways preferably operate, a message and/or attached file is queued at the gateway or threshold prior to release or reception of the information onto or from the network (step 305). In some situations, it may be necessary to disable watermark detection, for example, for certain transfers deemed safe (such as legitimate copying between a user's own computers) or when the checking is otherwise disabled (pursuant to user transfer permissions). If watermark detection (step 310) is disabled, then the file is released and it is either transmitted or received (step 315). Otherwise, the file is examined for watermarks (step 320). If no watermarks are detected, then the file is released (step 315). Where watermarks are present in the file, then any further transmission is blocked (step 330), whether going to or coming from the network. A message indicating that the file has been blocked (step 335) can also be generated, alerting the sender of the blockage. A message may also be sent to the intended recipient indicating the problem.

Because of the speed and power necessary to decode a watermark, the watermark detection software preferably resides on a proprietary hardware unit that, through an Ethernet connection or fiber connection, will connect and run inside the ISP's server structure. In time, speed of ISP proxy servers will make it a simple thing to run a software-only version of the watermarking detection system.

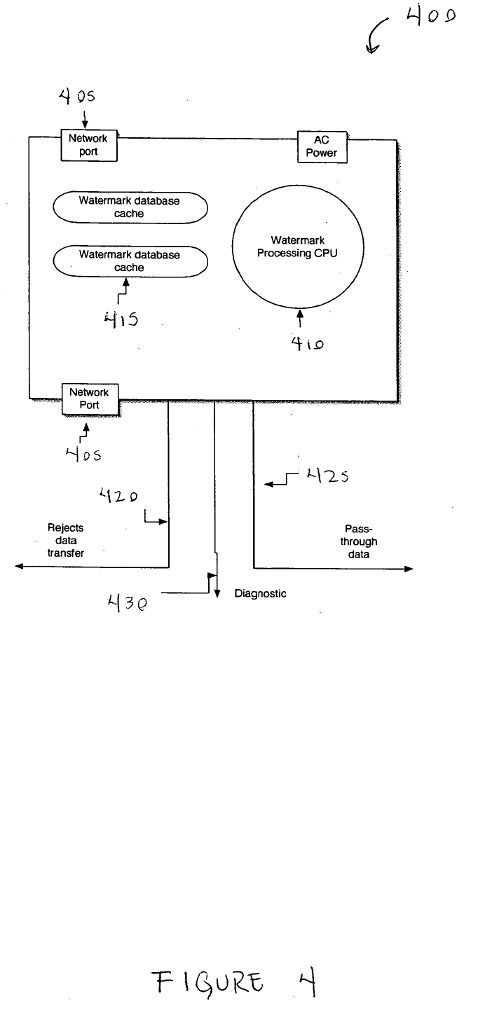

With reference now to FIG. 4, there is shown a watermark detector gateway, such as the watermark detector gateway 220, 240, generally designated by the reference numeral 400. The watermark detector gateway 400 is connected to an ISP infrastructure by a network connection 405 and acts as a conduit for ISP traffic and analyzes packets of data for any watermarks. The watermark detection processing central processing unit (CPU) 410 analyzes the packets and, when it finds a watermark, it compares that watermark to a cached database 415 of watermarks. There are several rules that the watermark detector gateway 400 can now follow, depending upon the rules and requirements of the content owners. The watermark detector gateway 400 can reject the transfer 420 of the data by blocking, thereby preventing the file from going to any other peers on the file sharing network. The watermark detector gateway 400 can pass-through the transfer of data 425. Depending on the data in the watermark, the watermark detector gateway 400 can analyze it and send a diagnostic 430 of what files are being traded to a central forensic server for further study.

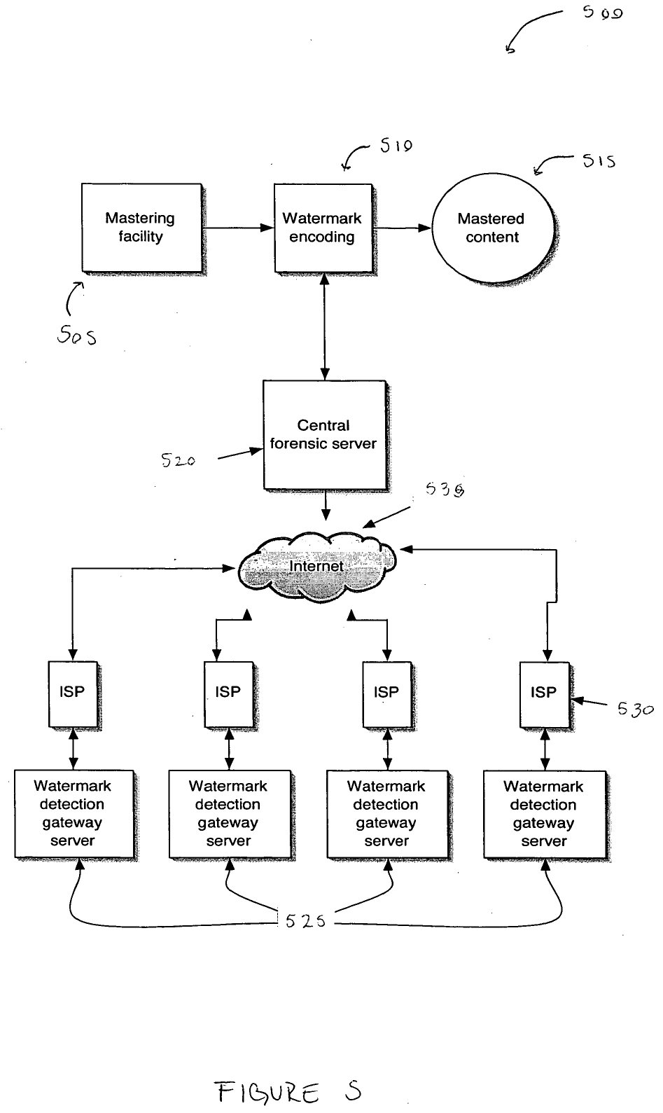

With reference now to FIG. 5, there is shown therein a network for watermark encoding and data tracking, generally designated by the reference numeral 500. During mastering, which can be done any type of media that can be transferred electronically, the mastering facility 505 embeds a watermark using a watermark insertion device 510, creating mastered content 515 that can be duplicated and distributed. The nature of this watermark is determined by a pre-defined set of criteria. A watermark can have a variety of information on it, e.g., content name, copyright owner and year, etc. The information is pushed to the watermark encoding hardware by a secure internet connection to the central forensic server 520. This central forensic server 520 distributes the final watermarks to the mastering facility 505 and then records that the specific content now has a watermark embedded within it. The central forensic server 520 then queries all children watermark servers 525 connected to the ISPs 530 through an encrypted connection across the Internet 535. Because the central forensic server 520 now has new watermarks for the watermark detection gateways 525 to monitor for, the central forensic server 520 distributes these warning flags to the watermark detection gateways' 525 local watermarking database cache. This, in turn, triggers the instructions on whether to block transmission of the file, flag the file for further forensic testing, or allow the transfer of the packets through the ISP 530. In this way, the ISPs 530 and the watermark detection gateways 525 are prepared for early file sharing and distribution before the mastered content 515 has gone through duplication.

A known method of tracking data with watermarks includes automated recognition, using a smart agent to crawl through the files on file sharing networks and sample a few seconds of available downloads. The smart agent has a database list of files that the content owner has decided to investigate on file sharing networks, for example, the Billboard Top 100 music singles. Based on artist name, track name, or album name (these names can be any media descriptions that are usually searched on file sharing networks), the agent will automatically begin querying the specific file sharing protocols and determine a list of candidate files available to download. The agent then will begin downloading a sample of the files. The agent will calculate the sample from the reported file size of the download, so that if a file is a five megabyte download, the agent will download a predetermined percentage of that file, which can be predetermined by configuration parameters. Some watermarks are noticeable within the first few seconds of a media file, so the agent will only necessarily download two or three percent of the available shared file.

This method of detection, however, merely presents a diagnostic method for discovering watermarks, but it does not force any type of compliance on the user to stop distributing files. In fact, recognizing a watermark does not, in itself, point to culpability, since it is difficult to say which Internet Protocol (IP) address matches which watermark with which user. All this functionality does is determine which files have watermarks and which do not. There are methodologies of matching IP addresses to a legitimate digital file, but since most IP addresses are dynamic, it is futile to always assume that a particular IP should always be linked to a particular watermark.

Besides giving a global forensic outlook on the state of file sharing or illicit digital file distribution, a watermark's strength is in determining the original owner of a file (this information is part of the watermark). If multiple identical files all share the same watermark, then it is likely that they have been distributed illegitimately. The content owner can then trace the file back to its origin and take whatever measures necessary.

Yet this all assumes active participation on behalf of the content owner, which is not necessarily a good assumption. Hunting down watermarks through file sharing networks, although perfectly feasible with the intelligent agent mechanism described above, only adds to the burden that content owners currently face in stemming the use of file sharing.

Once the detection system of the present invention analyzes and detects a valid watermark, the system will block the transfer of that file from the ISP's gateway out to the Internet or to another user. Since the system will work at all ISP levels, the hardware can detect a file being sent as well as a file coming in to the ISP's network. The watermark detection system can detect and stop the transfer of the file both ways.

There is a mechanism in the detection system to let a watermarked file travel through the gateway unimpeded (this is if users have legitimate files they would like to send from one computer they own to another computer they own). Here the watermark will have a flag that toggles on or off depending on file transfer permissions that the user has.

What this invention claims is the ability of blocking a watermarked digital file at one of the points of distribution by a mechanism that sits at the ISP. This is the filtering agent that will analyze files flowing in and out of the ISP's gateway, check them for watermarks, and prevent them from moving any further on the network once a watermark has been detected. At the ISP server level, the watermark detection process sits between incoming and outgoing electronic traffic and, much like a spam filter piece of software, it checks incoming and outgoing files. Unlike spam filter software, the process does not run checks on any file name description of the content but instead runs a dedicated watermarking analysis on the structure of the file itself.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents

1. A system for protecting digital transmissions from piracy, said system comprising:
a watermark detector, said watermark detector processing an incoming file automatically upon receipt and sampling said file for the presence of at least one watermark within said file; and
a blocking device for blocking transmission of said file upon detection by said watermark detector of said at least one watermark within said file.

2. The system for protecting digital transmissions of claim 1, further comprising a watermark insertion device for adding said watermark to said file.

3. The system for protecting digital transmissions of claim 1, further comprising a smart agent to crawl through sharable files on a file sharing network to sample a portion of said sharable files.

4. The system for protecting digital transmissions of claim 3, wherein said portion of said sharable file is determined by the size of said sharable file.

5. The system for protecting digital transmissions of claim 1, wherein said blocking of said file upon detection of said at least one watermark indicates multiple identical files contain the same watermark.

6. The system for protecting digital transmissions of claim 1, further comprising a blocking device bypass mechanism to allow a watermarked file to travel through said blocking device unimpeded.

7. A method for protecting digital transmissions from piracy, said method comprising:
receiving a file;
detecting the presence of at least one watermark within said file, said detecting step occurring automatically upon receipt of said file; and
blocking transmission of said file upon detection of said at least one watermark within said file.

8. The method for protecting digital transmissions of claim 7, wherein said detected at least one watermark is intrinsic to said file.

9. The method for protecting digital transmissions of claim 8, wherein the step of detecting the presence of said at least one watermark further comprises performing watermarking analysis on the structure of said file.

10. The method for protecting digital transmissions of claim 9, further comprising allowing said file comprising at least one watermark to travel through a blocking device unimpeded.

11. The method for protecting digital transmissions of claim 7, wherein said transmission of said file is an outgoing transmission.

12. The method for protecting digital transmissions of claim 7, wherein said transmission of said file is an incoming transmission.

13. A watermark detector comprising:
a receiving means for receiving a file; and
a detector, said detector processing said file automatically upon receipt at said receiving means, and sampling said file for the presence of at least one watermark within said file.

14. The watermark detector of claim 13, wherein said detector runs within the structure of an Internet Service Provider server.

15. The watermark detector of claim 14, wherein said detector running within said structure of said Internet Service Provider server further comprises a proprietary hardware unit configured to run watermark detection software.

16. The watermark detector of claim 15, wherein said at least one watermark comprises a flag that toggles depending upon a user's type of file transfer permission.

17. A watermark detector gateway comprising:
a receiving means for receiving a file;
a detector, said detector processing said file automatically upon receipt at said receiving means, and sampling said file for the presence of at least one watermark within said file; and
a blocking device for blocking transmission of said file upon detection of said at least one watermark within said file.

18. The watermark detector gateway of claim 17, wherein said detector runs within the structure of an Internet Service Provider server.

19. The watermark detector gateway of claim 18, wherein said detector running within said structure of said Internet Service Provider server further comprises a proprietary hardware unit configured to run watermark detection software.

20. The watermark detector gateway of claim 19, wherein said at least one watermark comprises a flag that toggles depending upon a user's type of file transfer permission.
